(19) United States
(12) Patent Application Publication
(10) Pub. No.: US 2026/0180666 A1
(43) Pub. Date: Jun. 25, 2026

(54) WIRELESS DEVICE SENSING FOR IMPROVED BEAM TRACKING

(71) Applicant: Telefonaktiebolaget LM Ericsson (publ), Stockholm (SE)

(72) Inventors: Muris SARAJLIC, Malmö (SE); Henrik SJÖLAND, Lund (SE); Magnus SANDGREN, Staffanstorp (SE)

(21) Appl. No.: 19/129,234

(22) PCT Filed: Nov. 14, 2022
(86) PCT No.: PCT/EP2022/081821

§ 371 Date: May 12, 2025

(51) Int. Cl. H04B 7/08; H04B 7/04; H04B 7/0408; H04W 72/02; H04W 72/044

(52) U.S. Cl. CPC H04B 7/088; H04B 7/04013; H04B 7/0408; H04W 72/02; H04W 72/046

(57) ABSTRACT

A method, system and apparatus for wireless device (WD) sensing for improved beam tracking are disclosed. According to one aspect, a method includes transmitting a sensing signal in a first beam direction on a transmit beam having a first beam pattern. The method also includes receiving a signal from a second beam direction on a receive beam having a second beam pattern. The method also includes determining whether the received signal includes a reflected signal from a reflector located at the network node based at least in part on knowledge of properties of the reflected signal.

### TECHNICAL FIELD

The present disclosure relates to wireless communications, and in particular, to wireless device (WD) sensing for improved beam tracking.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

In addition to these standards, the Institute of Electrical and Electronic Engineers (IEEE) has developed and continues to develop standards for other types of wireless communication networks, including Wireless Local Area Networks (WLANs), including Wireless Fidelity (Wi-Fi) networks. WLANS include wireless communication between access points (APs) and WDs. Radio communication in mmWave frequency bands (30-300 GHz) enables the use of extensive-and previously underexploited-frequency resources (on the order of GHz for contiguous spectrum allocations, and tens of GHz for non-contiguous allocations). Wide bandwidths available in mm Wave communications translate to greatly increased per-user and system throughputs compared with legacy radio communication systems operating at lower frequencies. This serves as a motivation for adopting the use of mmWave bands in upcoming radio standards, and this adoption has already started, with 5G NR (3GPP Technical Releases 15-16) prescribing the use of bands up to 52.6 GHz and 3GPP Technical Release 17 expanding coverage to the frequency range 52.6-71 GHz. Adoption of mmWave bands is also employed in the IEEE 802.11 family of standards. Expanding the operation beyond 70 GHz (and especially beyond 100 GHz) is the subject of ongoing research.

Operating at mm Wave frequencies and large bandwidths (on the order of GHz or tens of GHz) comes with a host of technical challenges. The following fundamental challenges have been recognized:
1. Antenna area (in an electromagnetic sense) shrinks with increasing operating frequency. This reduces the amount of power being received by a single high-frequency antenna compared to its low-frequency counterparts;
2. Physical size of the power amplifiers (PAs) decreases with increasing operating frequency, and with the decrease in size, the maximum power the PAs can deliver decreases; and
3. Operating at large bandwidths incurs increased power consumption of analog circuitry and especially analog-to-digital converters.

A direct consequence of challenges 1 and 2 is a significant decrease of received (Rx) power compared to the received power when operating at lower frequencies. A typical way to compensate for received power loss is to employ an array of antennas configured to receive and transmit. When transmitting, each antenna is driven by an individual power amplifier (PA). Using an array of antennas enables transmitting the power in a certain direction (and likewise, focusing the reception to a certain direction), effectively resulting in a gain that compensates for lost power. When receiving, the antenna gain may be increased and directed. Power may be directed to and received from a certain direction by individually shifting the signal phases at each antenna element, causing the copies of the signal (to and from a desired direction) at each antenna element to add constructively. This directivity is abstracted by the concept of a beam, and transmit (Tx) and receive (Rx) beams may be distinguished.

A typical way of dealing with challenge 3 is to employ a small number of digital transceiver (Tx-Rx) chains, sometimes only one or two, to reduce the number of analog-to-digital converters and keep the power consumption low. In this configuration, signal weighting as described above (beamforming) needs to be performed mostly in the analog domain (analog beamforming).

The described typical solutions, in turn, cause further practical problems. Namely, for beamforming performed in the analog domain, it is convenient from an implementation perspective to only provide a single signal phase shift for each antenna element. A set of per-antenna phase shifts will determine one particular beam direction. This means that only one direction at a time may be illuminated by a beam. Also, the large array gain needed at mm Wave comes at the price of very narrow beams due to a fundamental tradeoff between array gain and beamwidth; a large number of beams is therefore needed to cover a typically used angular range, e.g., 120 degrees horizontal by 90 degrees vertical.

For the best link budget, beamforming is performed both at the transmitter and the receiver. In a system with M transmit beams and N receive beams (illustrated in FIG. 1 in a downlink DL setup), and with the use of analog beamforming, finding the optimal beam pair typically includes a transmitter sending reference signals (RSs) separately in each transmit beam and a receiver receiving in each receive beam, where all receive beams are tested for each transmit beam (in order to exhaust all transmit-receive combinations). Taking a trivial example with N=M=2, the transmitter may transmit the RS in transmit beam 1 and the receiver may receive this transmission first with receive beam 1 and then with receive beam 2. In the second step, the transmitter may transmit with transmit beam 2 and the receiver may receive the transmission first with receive beam 1 followed by receive beam 2. In this way, all 4 transmit-receive beam combinations are tested. Following the receptions, the receiver measures the quality of the received signal in each reception. Measured quality is used internally in the receiver to determine the best receive beam; if the target is to determine the best transmit beam, measured quality is reported to the transmitter. The described measurement procedure requires NM time resources in the worst case. This may prove to be unsatisfactory from the perspective of both resource consumption and latency if N and M are large, as they tend to be in mm Wave scenarios.

A standard part of receiver operation when using beamforming is receive beam tracking, i.e., the process of verifying whether the currently used receive beam is still offering the best received signal quality, and if not, determining which receive beam does provide the best reception quality. Receive beam tracking is based on measurements on beamformed reference signals (RSs) sent by the transmitter, following the procedure described above. Measurements are handled internally by the receiver and do not need to be reported to the transmitter. The focus is on the downlink (DL) scenario, where the base station or AP (hereafter referred to as a network node) is the transmitter and the WD is the receiver. At least the following challenges are presented:
1. Receive beam tracking consumes downlink (DL) resources. Resource consumption (in terms of time-frequency resources or energy) of WD-specific downlink reference signals (for example, beamformed channel state information reference signals (CSI-RS) in 5G NR) scales linearly with the number of served WDs. This may constitute a significant resource overhead in scenarios with high mobility, for example, where optimal receive beams change rapidly, and with a large number of users. Overhead is additionally exacerbated in scenarios where there are two or more serving radio nodes, e.g., in multi-transmission/reception point (TRP) or D-multiple input-multiple output (MIMO) setups. While a part of WD-specific reference signal resources are consumed by the procedure of finding the best transmit beam at the network node, another part is consumed by receive beam tracking at the WD; and
2. Receive beam tracking may incur significant latency. Receive beam tracking may also be based on measurements on beamformed RSs that are transmitted by the network node in the DL periodically and are common to all served WDs (e.g., beamformed synchronization signal block (SSB) in 5G NR). In contrast to challenge 1, the signaling overhead is independent of the number of users. However, the time period T between transmissions of such reference signal may be too long for achieving satisfying latency in some scenarios. The case where the WD experiences a rotation may be considered as an example. The WD needs to test its receive beams one by one but only gets the chance to do the testing every T seconds. The resulting worst-case latency for receive beam establishment is therefore NT seconds. In NR, the default synchronization signal block (SSB) periodicity is T=20 ms, and therefore the worst-case latency caused by WD rotation may be on the order of 100 ms which may be unsatisfactory for latency-sensitive applications.

### SUMMARY

Some embodiments advantageously provide methods and wireless devices for wireless device (WD) sensing for improved beam tracking.

Some embodiments include a method for finding the best receive and transmit beams at the WD, where the WD performs beamformed monostatic sensing of the environment, i.e., the WD sends a signal and receives the reflections of the sent signal using different receive beams. One or more reflections in one or more receive beam(s) may be identified as coming from the direction of the serving network node and the corresponding receive beams are then taken to be likely candidates for the best receive beam. Similarly, one or more transmit beams can be identified as being in the direction of the serving network node and likely candidates for the best transmit beam may be identified.

For the purpose of identifying the reflection coming from the direction of the network node, i.e., distinguishing from other reflections generated by the propagation environment, the network node may be collocated with a passive or active device that simultaneously reflects and modifies selected properties of the incoming signal from the WD in a known way, with the modification being recognizable by the WD.

The solution enables the WD to find the best receive beam (and transmit beam, if receive and transmit beams are different) independently of network reference signaling in the DL. In so doing:
WD-specific downlink (DL) reference signaling resources used for beam tracking at the WD are freed up, i.e., resource overhead for reference signaling in the DL is reduced; and/or
latency of beam reestablishment may be reduced, which may be of particular importance in cases when beam tracking relies on periodic DL RSs common to all served WDs (such as SSB in 5G NR).

According to one aspect, a method in a wireless device, WD, configured to communicate with a network node is provided. The method includes transmitting a sensing signal in a first beam direction on a transmit beam having a first beam pattern. The method also includes receiving a signal from a second beam direction on a receive beam having a second beam pattern. The method further includes determining whether the received signal includes a reflected signal from a reflector located at the network node based at least in part on knowledge of properties of the reflected signal.

According to this aspect, in some embodiments, the second beam direction is a same beam direction as the first beam direction. In some embodiments, when transmitting the sensing signal in the first beam direction, the method includes sweeping the second beam direction in a plurality of directions and for each second beam direction, determining whether the received signal includes a reflected signal from a reflector at the network node. In some embodiments, sweeping the second beam direction includes sweeping the second beam direction in an angular range that is based at least in part on a rotation of the WD indicated by the inertial measurement unit (IMU). In some embodiments, the second beam direction is determined based at least in part by adding the rotation to a value of a second beam direction for which the signal includes the reflected signal from the reflector at the network node. In some embodiments, the process also includes testing a plurality of transmit beam directions in an angular range that is based at least in part on a rotation of the WD 22 indicated by an inertial measurement unit, IMU. In some embodiments, the method includes selecting a second beam of a plurality of second beams that includes a signal from a reflector, and using the selected second beam for subsequent communications with the network node at which the reflector is located. In some embodiments, the selecting is based at least in part on at least one of a power of the signal, a history of channel characteristics and information from an inertial measurement unit, IMU. In some embodiments, the method includes selecting another receive beam when a reference signal received quality corresponding to a previously selected receive beam falls below a threshold. In some embodiments, the sensing signal is separated in at least one of time and frequency from control and data signaling. In some embodiments, the method also includes selecting a receive beam for each of a plurality of network nodes corresponding to reflectors from which a reflected signal is received. In some embodiments, the method also includes simultaneously selecting a receive beam and a transmit beam corresponding to different beam directions for use in subsequent communications with a same network node. In some embodiments, the method includes simultaneously selecting a receive beam for receiving from a first network node and selecting a transmit beam for transmitting to a second network node different from the first network node. In some embodiments, properties of the reflected signal include at least one of angle, delay, phase, impulse response and power. In some embodiments, knowledge of the properties of the reflected signal includes knowledge of at least one of notches in a frequency response of the reflected signal and a predefined information sequence modulated onto the reflected signal by the reflector. In some embodiments, the method includes selecting a receive beam from a plurality of receive beams having a reflected beam from a reflector, the selecting being based at least in part on a relationship between a beam power and beam delay, and a history of channel characteristics. According to another aspect, a WD configured to communicate with a network node, includes a radio interface configured to: transmit a sensing signal in a first beam direction on a transmit beam having a first beam pattern; and receive a signal from a second beam direction on a receive beam having a second beam pattern. The WD also includes processing circuitry in communication with the radio interface and configured to determine whether the received signal includes a reflected signal from a reflector at the network node based at least in part on knowledge of properties of the reflected signal.

In some embodiments, the second beam direction is a same beam direction as the first beam direction. In some embodiments, the processing circuitry is further configured to sweep the second beam direction in a plurality of directions when transmitting the sensing signal in the first beam direction, and for each second beam direction, determining whether the received signal includes a reflected signal from a reflector at the network node. In some embodiments, sweeping the second beam direction includes sweeping the second beam direction in an angular range that is based at least in part on a rotation of the WD indicated by the IMU. In some embodiments, the second beam direction is determined based at least in part by adding the rotation to a value of a second beam direction for which the signal includes the reflected signal from the reflector at the network node. In some embodiments, the process also includes testing a plurality of transmit beam directions in an angular range that is based at least in part on a rotation of the WD 22 indicated by an inertial measurement unit, IMU. In some embodiments, the processing circuitry is further configured to select a second beam of a plurality of second beams having a reflected signal from a reflector and use the selected second beam for subsequent communications with the network node at which the reflector is located. In some embodiments, the selecting is based at least in part on at least one of a power of the signal, a history of channel characteristics and information from an inertial measurement unit. IMU. In some embodiments, the processing circuitry is further configured to select another receive beam when a reference signal received quality corresponding to a previously selected receive beam falls below a threshold. In some embodiments, the sensing signal is separated in at least one of time and frequency from control and data signaling. In some embodiments, the processing circuitry is further configured to select a receive beam for each of a plurality of network nodes corresponding to reflectors from which a reflected signal is received. In some embodiments, the processing circuitry is further configured to simultaneously select a receive beam and a transmit beam corresponding to different beam directions for use in subsequent communications with a same network node. In some embodiments, the processing circuitry is further configured to simultaneously select a receive beam for receiving from a first network node and selecting a transmit beam for transmitting to a second network node network node different from the first network node. In some embodiments, properties of the reflected signal include at least one of angle, delay, phase, impulse response and power. In some embodiments, knowledge of the properties of the reflected signal includes knowledge of at least at least one of notches in a frequency response of the reflected signal and a predefined information sequence modulated onto the reflected signal by the reflector. In some embodiments, the processing circuitry is further configured to select a receive beam from a plurality of receive beams having a reflected beam from a reflector, the selecting being based at least in part on a relationship between a beam power and beam delay, and a history of channel characteristics.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein: FIG. 1 illustrates transmit beams and receive beams;

FIG. 2 is a schematic diagram of an example network architecture illustrating a communication system according to principles disclosed herein;

FIG. 3 is a block diagram of a network node in communication with a wireless device over a wireless connection according to some embodiments of the present disclosure;

FIG. 4 is a flowchart of an example process in a wireless device for wireless device (WD) sensing for improved beam tracking;

FIG. 5 illustrates a transmit antenna panel of a WD transmitting a reference signal and a receive panel of the WD receiving a modified reflected signal;

FIG. 6 illustrates received signals for different receive beams; and

FIG. 7 illustrates a delay-angle power characteristic for beam tracking using sensing according to principles set forth herein.

### DETAILED DESCRIPTION

Before describing in detail example embodiments, it is noted that the embodiments reside primarily in combinations of apparatus components and processing steps related to wireless device (WD) sensing for improved beam tracking. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “includes,” “including,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “includes,” “including,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein may be any kind of network node included in a radio network which may further include any of base station (network node), radio base station, base transceiver station (BTS), base station controller (network node), radio network controller (RNC), g Node B (gNB), evolved Node B (eNB or eNodeB), Node B, multi-standard radio (MSR) radio node such as MSR network node, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also include test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It may be any kind of a radio network node which may include any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), wireless local area networks, Wi-Fi, may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

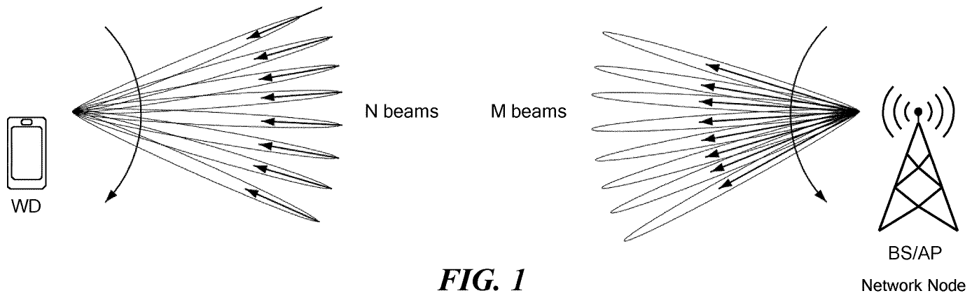

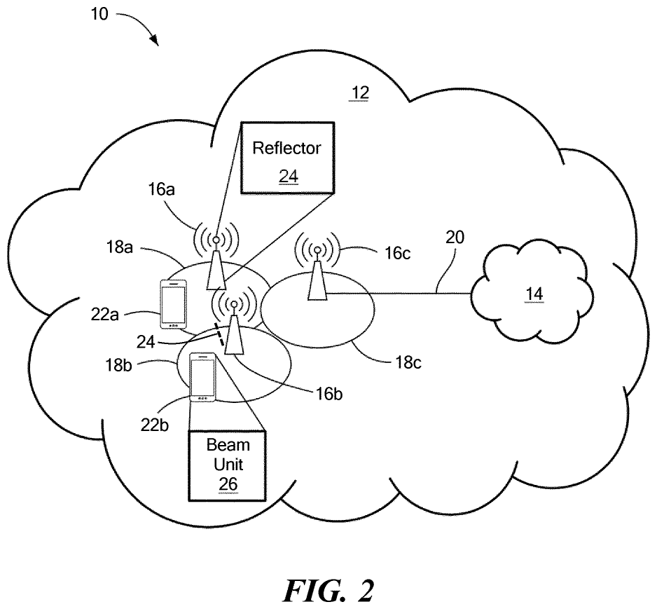

Some embodiments are directed to wireless device (WD) sensing for improved beam tracking. Referring again the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which includes an access network 12, such as a radio access network, and a core network 14. The access network 12 includes a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-universal radio access network (UTRAN) and a gNB for NR/NG-radio access network (RAN).

In proximity to a network node 16 (eNB or gNB) there is a reflector 24 which is configured to modify and reflect a received signal. A wireless device 22 is configured to include a beam unit 26 which is configured to determine whether the received signal includes a reflected signal from a reflector at the network node based at least in part on knowledge of properties of the reflected signal.

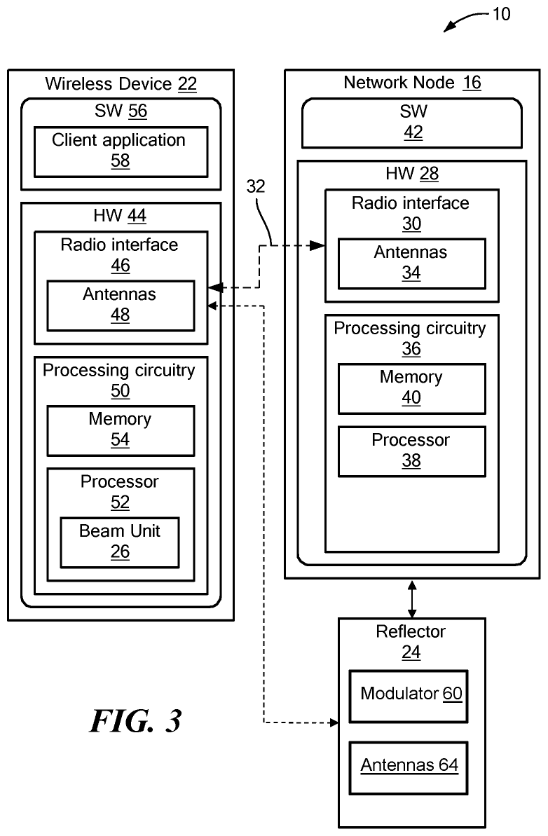

Example implementations, in accordance with an embodiment, of the WD 22 and network node 16 discussed in the preceding paragraphs will now be described with reference to FIG. 3.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal-carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further include software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include a beam unit 26 which is configured to determine whether the received signal includes a reflected signal from a reflector at the network node based at least in part on knowledge of properties of the reflected signal.

In proximity to the network node 16 is a reflector 24 which is configured to modulate and reflect an incident signal to produce a modulated reflected signal that enables the WD 22 to determine a direction to the network node 16. The reflector 24 includes a modulator 60 which is configured to modulate an incident signal. This may be done by varying the impedances of antennas 64 of the reflector 24.

In some embodiments, the inner workings of the network node 16 and WD 22 may be as shown in FIG. 3 and independently, the surrounding network topology may be that of FIG. 2.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 2 and 3 show various “units” such as beam unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

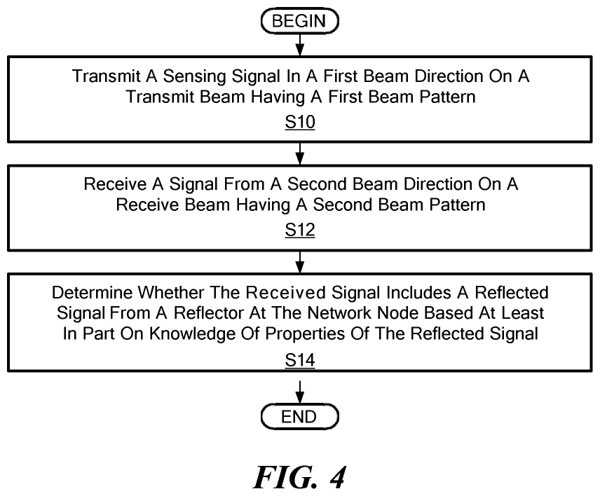

FIG. 4 is a flowchart of an example process in a wireless device 22 according to some embodiments of the present disclosure. One or more blocks described herein may be performed by one or more elements of wireless device 22 such as by one or more of processing circuitry 50 (including the beam unit 26), processor 52, and/or radio interface 46. Wireless device 22 such as via processing circuitry 50 and/or processor 52 and/or radio interface 46 is configured to transmit a sensing signal in a first beam direction on a transmit beam having a first beam pattern (Block S10). The method also includes receiving a signal from a second beam direction on a receive beam having a second beam pattern (Block S12). The method further includes determining whether the received signal includes a reflected signal from a reflector 24 located at the network node based at least in part on knowledge of properties of the reflected signal (Block S14).

In some embodiments, the second beam direction is a same beam direction as the first beam direction. In some embodiments, when transmitting the sensing signal in the first beam direction, the method includes sweeping the second beam direction in a plurality of directions and for each second beam direction, determining whether the received signal includes a reflected signal from a reflector 24 at the network node 16. In some embodiments, sweeping the second beam direction includes sweeping the second beam direction in an angular range that is based at least in part on a rotation of the WD 22 indicated by the IMU. In some embodiments, the second beam direction is determined based at least in part by adding the rotation to a value of a second beam direction for which the signal includes the reflected signal from the reflector 24 at the network node 16. In some embodiments, the process also includes testing a plurality of transmit beam directions in an angular range that is based at least in part on a rotation of the WD 22indicated by an inertial measurement unit, IMU. In some embodiments, the method includes selecting a second beam of a plurality of second beams that includes a signal from a reflector 24, and using the selected second beam for subsequent communications with the network node 16 at which the reflector 24 is located. In some embodiments, the selecting is based at least in part on at least one of a power of the signal, a history of channel characteristics and information from an inertial measurement unit, IMU. In some embodiments, the method includes selecting another receive beam when a reference signal received quality corresponding to a previously selected receive beam falls below a threshold. In some embodiments, the sensing signal is separated in at least one of time and frequency from control and data signaling. In some embodiments, the method also includes selecting a receive beam for each of a plurality of network nodes 16 corresponding to reflectors 24 from which a reflected signal is received. In some embodiments, the method also includes simultaneously selecting a receive beam and a transmit beam corresponding to different beam directions for use in subsequent communications with a same network node 16. In some embodiments, the method includes simultaneously selecting a receive beam for receiving from a first network node 16 and selecting a transmit beam for transmitting to a second network node 16 different from the first network node 16. In some embodiments, properties of the reflected signal include at least one of angle, delay, phase, impulse response and power. In some embodiments, knowledge of the properties of the reflected signal includes knowledge of at least one of notches in a frequency response of the reflected signal and a predefined information sequence modulated onto the reflected signal by the reflector 24. In some embodiments, the method includes selecting a receive beam from a plurality of receive beams having a reflected beam from a reflector 24, the selecting being based at least in part on a relationship between a beam power and beam delay, and a history of channel characteristics.

Having described the general process flow of arrangements of the disclosure and having provided examples of hardware and software arrangements for implementing the processes and functions of the disclosure, the sections below provide details and examples of arrangements for wireless device (WD 22) sensing for improved beam tracking.

Some embodiments include a method for finding the best receive beam at the WD 22 in a wireless system. The method includes sending a sensing signal to an object using the transmitter subsystem of the radio interface 46 of the WD 22, optionally using a transmit beam. The receiver subsystem of the radio interface 46 of the WD 22 receives the reflections of the sent signal from objects in the surrounding environment, while employing different receive beams. The network node 16 is physically co-located with an active or passive reflector 24 that reflects the incoming signals. The reflector 24 changes one or more properties of the incoming signals (time-domain waveform, frequency characteristic, polarization) and reflects the incoming signals in the same, or approximately the same, direction as the direction of the incoming signals. The manner in which the reflector 24 modifies the reflected signal is known to the WD 22. The WD 22, using the knowledge of the manner in which the reflected signal is modified by the reflector 24, identifies the reflection coming from the direction of the network node 16 in one or more receive beams.

The WD 22, using a transmit antenna panel 48a and associated circuitry (radio interface 46 and processing circuitry 50), performs beamformed transmissions of a sensing signal p(t).

The same WD 22, using a receive antenna panel 48b and associated circuitry of the radio interface 46 and processing circuitry 50, simultaneously performs beamformed receptions of the reflected and possibly modified signal p(t), the modification denoted by \tilde{p}(t). In one embodiment, the radio interface 46 repeats the transmission of p(t) in the same transmit beam L times and for each of these transmissions, sweeps the receive beam. For each transmit-receive beam pair and using both p(t) and \tilde{p}(t), the WD 22 analyzes the properties of the corresponding reflections (received power/energy, angle, mean delay, impulse response, phase, etc.).

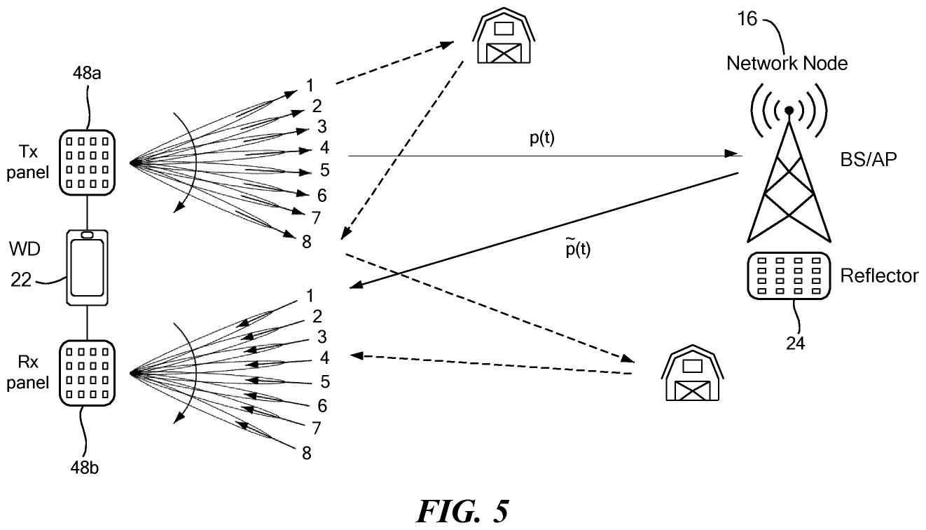

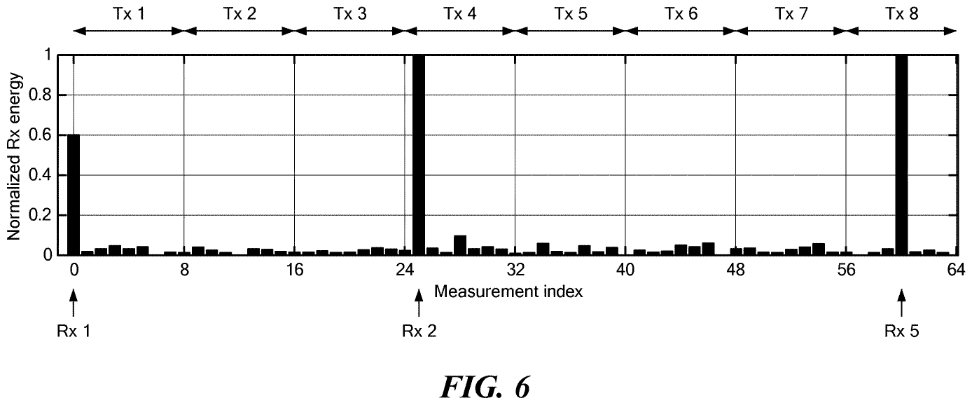

An illustration of an example output of such an analysis corresponding to the scenario illustrated in FIG. 5 is illustrated in FIG. 6. Measured energy spikes at (transmit beam 1, receive beam 1) and (transmit beam 8, receive beam 5) come from the objects in the environment; the spike at (transmit beam 4, receive beam 2) corresponds to the reflection from the physical location of the network node 16.

If the signal that is reflected from the general area of the network node 16 is modified in a way known to the WD 22, the WD 22 can, through postprocessing, distinguish which of the reflections came from the direction of the network node 16. The signal-modifying functionality may be implemented by the reflector 24 which is collocated with the network node 16. The reflector 24 reflects and possibly amplifies the incoming signal (which improves the link budget) and also modifies some property of the signal.

In some embodiments the reflector 24 may perform one or more of the following:
the reflector 24 may change the spectrum of the reflected signal by introducing a number of notches in predefined frequency positions. During the postprocessing of the signal reflections, the WD 22 may observe the spectra of the reflections and find that the spectrum of one of the reflections contains notches in expected frequency positions; this reflection may then be identified as coming from the direction of the network node 16; and/or
the reflector 24 may modulate the incoming signal by a predefined information sequence by using, e.g., on-off-keying (OOK). The WD 22 is assumed to know the modulating information sequence. By postprocessing the received reflected signals, the WD 22 may observe that one of the signals is modulated while others are not; this reflection may then be assumed to come from the direction of the network node 16.

### Example Calculation of Scanning Time

Assuming that the WD 22 has 256 transmit beams and 64 receive beams and that the time taken for one transmission of p(t) is 100 ns, the beamformed sensing procedure will take 256*64*100ns=1.6 ms which is a factor of 100 less than the time needed to reestablish the beam using legacy signaling in NR.

### Example Link Budget Calculation for Carrier Frequency of 300 GHz

Assume a short edge length a=2cm for a corner reflector 24, i.e., 2\sqrt{2}=2.8 cm for the long edges. The wavelength at 300 GHz is λ=3e8/300e9=1mm. The radar cross section (RCS) then becomes 4πa⁴/(322) =0.67 square meters.

If the device searching for the beam direction has:
−5dBm output power per antenna;
256 transmit antennas (256=24 dB); and
5 dB antenna element gain; then the equivalent isotropic radiated power (EIRP) becomes −5+24+5+24=48 dBm.

For the WD receiver circuitry of the radio interface 46, assume a 20 dB noise figure, and 64 antenna elements (64=18 dB). To find the presence of the reflector 24, assume a radar pulse length of 100 ns (−70 dBs). The noise floor then becomes −174+20+70 dB=−84 dBm The received power at a 10m distance becomes: EIRP+receiver antenna gain+10*log(lambda\hat{ }2*RCS/(4*pi)\hat{ }3*distance\hat{ }4)=48+23+10*log(1e−6*0.67/(4*pi)\hat{ }3*10\hat{ }4)=48+23−135=−64 dBm. The signal to noise ratio SNR=−64−(−84)=20 dB. The presence of the reflector 24 at a 10 m distance may thus be determined with a 100 ns pulse.

Some embodiments include a method in a WD 22 to combine the information obtained above with side information, such as:
a) information from an inertial measurement unit (IMU);
b) history of channel characteristics measured on DL RSs; and/or
c) a history of previously used transmit/receive beams to identify the candidates for best transmit/receive beam.

Assume that the WD 22 has already established the best receive beam towards the network node 16 corresponding to a particular angle of arrival, AoA, either through measurements on DL RSs or through sensing as described above, or both. If the WD 22 rotates or moves, the angle of arrival (AoA) towards the network node 16 may change. If the WD 22 is equipped with an IMU, the WD may approximately determine the angle of the rotation and may determine the range of AoAs in which the network node 16 is likely to be reached. Beamformed sounding may then be employed to sound the vicinity of the assumed new AoA. When a reflection is found in this new angular range and the properties (e.g., mean delay, signal strength, phase or impulse response) of the reflection are similar to previously seen reflections from the network node 16, and the WD 22 detects that the reflection has been modified in a preconfigured way, the WD 22 may ascertain that the reflection is coming from the direction of the network node 16. Then the newly established AoA—and corresponding receive beam—may be used to communicate with the network node 16. Note that in this application, only a subset of receive beams may be tested which speeds up the sounding process.

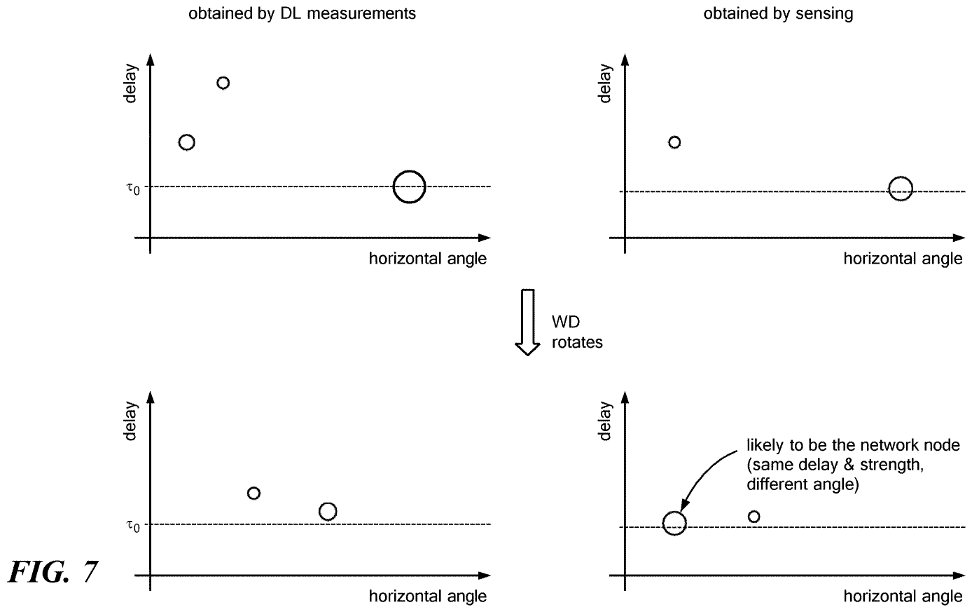

The WD 22 may also find the new receive beam by sensing in relying on previously obtained channel characteristics (measured on a DL RS) and/or environment properties determined through beamformed sensing. FIG. 7 illustrates this concept. Each of four subplots shows a delay—angle power characteristic of the channel/environment, with marker size denoting the relative power of the multipath component.

The top left figure illustrates a delay-angle characteristic of the DL channel obtained through DL measurements with the component pertaining to the direction of the network node 16 found at delay To. The top right figure illustrates the corresponding angle-delay characteristic obtained by monostatic sensing, with the component pertaining to the reflection from the network node 16 found at delay To and the same AoA as in the top left figure. After the rotation of the WD 22, channel characteristics obtained through sensing (bottom right figure) detects a significant component at the same delay To as before but at a new AoA; this component may be assumed to be from the reflector 24 at the network node 16. The assumption may be strengthened by using IMU data as described above. The receive beam that found this component is likely to be the new best beam towards the network node 16. The assumptions may be additionally corroborated by postprocessing the reflected signal and determining whether the reflected signal has been modified by the reflector 23 at the network node 16 in a predefined way. Note that a possible DL measurement performed using an outdated receive beam (bottom left figure) does not pick up the direction of the network node 16, but only spurious reflections from the objects in the environment.

Information from previously used transmit/receive beam pairs may be used to speed up the beam scan. For example, if the WD 22 has been in operation before, the WD 22 may use transmit and receive beam pairs from memory 54. Otherwise, the WD 22 may perform a receive/transmit beam pair search over some limited space. For example, the WD 22 may transmit with transmit beam 4, and listen with receive beams 3, 4 and 5. If receive beam 4 is the strongest receive beam, that is stored in memory 54, may use only receive beam 4 to receive communications from the network node 16.

In some embodiments, the sensing signal is separated in frequency and/or time from other control and data signals in the system. Separating the sensing signal in frequency and/or time from other signals will reduce the interference in the system. Separation in time requires a previously well-established time synchronization with the network node 16. In some embodiments, if the signal quality in the currently used receive beam is compromised, the WD 22 switches to using one of the identified candidate receive beams for future receptions. After inferring the likely directions towards the network node 16 using the methods described above, the WD 22 may use the receive beams corresponding to those directions for reception of signals from the network node 16.

In some embodiments, the best received beam among beams in the direction of a plurality of network nodes 16 is determined, e.g., in case of multi-TRP transmissions or D-MIMO. Some embodiments may be extended to a case where the WD 22 communicates with multiple network nodes 16, possibly spread out in space. In some applications, it may be beneficial for the WD 22 to identify the directions of individual nodes. Each of the nodes may apply a unique way of modifying the reflection. In some embodiments, the best transmit beam at the WD 22 is found simultaneously with the best receive beam.

Referring to the example illustrated in FIGS. 5 and 6, the transmit and receive directions towards the network node 16 may differ, and in the general case, transmit and receive beams towards the WD 22 will differ. Some embodiments may be used to also find the best transmit beam towards the network node 16 simultaneously with finding the best receive beam.

In some embodiments, the WD 22 initiates finding an appropriate receive and/or transmit beam as described above after a triggering event, e.g., an IMU signal that a WD 22 rotation has occurred, a drop in signal quality in the currently used beam, etc.

The beam scanning may be repeated periodically or may be performed aperiodically. In order to save uplink (UL) resources and reduce complexity, the scan may be performed only when triggered. For example, if a rotation of the WD 22 is detected by the IMU, it is likely that the best receive/transmit beam towards the network node 16 changed and the procedure may be performed. Likewise, the procedure may be performed if the signal quality in the currently used beam is determined to be consistently below the prescribed level.

Some embodiments may include a method for finding the best receive beam at the WD 22 in a wireless system, wherein: the WD 22 sends a sensing signal using its transmit subsystem of the radio interface 46, possibly using a transmit beam; the WD 22 receives the reflections of the sent signal from objects in the surrounding environment using its receiver subsystem of the radio interface 46 and employing different receive beams. The network node 16 is physically co-located with an active or passive reflector 24 that reflects the incoming signals. The reflector 24 may change one or more properties of the incoming signals (for example the time-domain waveform, frequency characteristic, and/or polarization). The reflector 24 reflects the incoming signals in the direction equal, or approximately equal, to the incoming direction. In some embodiments, the manner in which the reflector 24 modifies the reflected signal is known to the WD 22. The WD 22, using the knowledge of the manner in which the reflected signal is modified by the reflector 24, identifies the reflection coming from the direction of the network node 16 in one or more receive beams.

In some embodiments, the WD 22 combines the information obtained about the reflector direction with side information, such as: information from an inertial measurement unit (IMU), a history of channel characteristics measured on DL RSs; and/or a history of previously used transmit/receive beams. This combined information may be used to identify the candidates for best receive beam. In some embodiments, the sensing signal is separated in frequency and/or time from other control and data signals in the system. In some embodiments, when signal quality of the signal received in the receive beam falls below a threshold, the WD 22 switches to using one of the identified candidate receive beams for future receptions. In some embodiments, best receive beam among beams received from a plurality of network nodes 16 may be determined, e.g., in the case of multi-TRP transmissions or D-MIMO. In some embodiments, the best transmit beam at the WD 22 is found simultaneously with the best receive beam. In some embodiments, the WD 22 initiates a search for a receive beam and/or a transmit beam described above in response to a triggering event, e.g., an IMU signal that a WD 22 rotation has occurred, drop in signal quality in the currently used beam, etc.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a wireless device, WD, configured to communicate with a network node the method including:
transmitting a sensing signal in a first beam direction on a transmit beam having a first beam pattern;
receiving a signal from a second beam direction on a receive beam having a second beam pattern; and
determining whether the received signal includes a reflected signal from a reflector located at the network node based at least in part on knowledge of properties of the reflected signal.

2. (canceled)

3. The method of claim 1, further including, when transmitting the sensing signal in the first beam direction, sweeping the second beam direction in a plurality of directions and for each second beam direction, determining whether the received signal includes a reflected signal from a reflector at the network node.

4. The method of claim 3, wherein sweeping the second beam direction includes sweeping the second beam direction in an angular range that is based at least in part on a rotation of the WD indicated by an inertial measurement unit, IMU.

5. (canceled)

6. The method of claim 3, further comprising testing a plurality of transmit beam directions in an angular range that is based at least in part on a rotation of the WD indicated by an inertial measurement unit, IMU.

7. The method of claim 1, further including selecting a second beam of a plurality of second beams that includes a signal from a reflector, and using the selected second beam for subsequent communications with the network node at which the reflector is located, wherein the selecting is based at least in part on at least one of a power of the signal, a history of channel characteristics and information from an inertial measurement unit, IMU.

8.-10. (canceled)

11. The method of claim 1, further including selecting a receive beam for each of a plurality of network nodes corresponding to reflectors from which a reflected signal is received.

12. The method of claim 1, further including simultaneously selecting a receive beam and a transmit beam corresponding to different beam directions for use in subsequent communications with a same network node.

13. The method of claim 1, further including simultaneously selecting a receive beam for receiving from a first network node and selecting a transmit beam for transmitting to a second network node different from the first network node.

14. The method of claim 1, wherein properties of the reflected signal include at least one of angle, delay, phase, impulse response and power, wherein the knowledge of properties of the reflected signal includes knowledge of at least one of notches in a frequency response of the reflected signal and a predefined information sequence modulated onto the reflected signal by the reflector.

15. (canceled)

16. The method of claim 1, further including selecting a receive beam from a plurality of receive beams having a reflected signal from a reflector, the selecting being based at least in part on a relationship between a beam power and beam delay, and a history of channel characteristics.

17. A wireless device, WD, configured to communicate with a network node, the WD including:
a radio interface configured to:
transmit a sensing signal in a first beam direction on a transmit beam having a first beam pattern; and
receive a signal from a second beam direction on a receive beam having a second beam pattern; and
processing circuitry in communication with the radio interface and configured to determine whether the received signal includes a reflected signal from a reflector at the network node based at least in part on knowledge of properties of the reflected signal.

18. (canceled)

19. The WD of claim 17, wherein the processing circuitry is further configured to sweep the second beam direction in a plurality of directions when transmitting the sensing signal in the first beam direction, and for each second beam direction, determining whether the received signal includes a reflected signal from a reflector at the network node.

20. The WD of claim 19, wherein sweeping the second beam direction includes sweeping the second beam direction in an angular range that is based at least in part on a rotation of the WD indicated by an inertial measurement unit, IMU.

21. (canceled)

22. The WD (of claim 19, further comprising testing a plurality of transmit beam directions in an angular range that is based at least in part on a rotation of the WD indicated by an inertial measurement unit, IMU.

23. The WD of claim 17, wherein the processing circuitry is further configured to select a second beam of a plurality of second beams having a reflected signal from a reflector and use the selected second beam for subsequent communications with the network node at which the reflector is located, wherein the selecting is based at least in part on at least one of a power of the signal, a history of channel characteristics and information from an inertial measurement unit, IMU.

24.-26. (canceled)

27. The WD of claim 17, wherein the processing circuitry is further configured to select a receive beam for each of a plurality of network nodes corresponding to reflectors from which a reflected signal is received.

28. The WD of claim 17, wherein the processing circuitry is further configured to simultaneously select a receive beam and a transmit beam corresponding to different beam directions for use in subsequent communications with a same network node.

29. The WD of claim 17, the processing circuitry is further configured to simultaneously select a receive beam for receiving from a first network node and selecting a transmit beam for transmitting to a second network node network node different from the first network node.

30. The WD of claim 17, wherein properties of the reflected signal include at least one of angle, delay, phase, impulse response and power, wherein knowledge of the properties of the reflected signal includes knowledge of at least at least one of notches in a frequency response of the reflected signal and a predefined information sequence modulated onto the reflected signal by the reflector.

31. (canceled)

32. The WD of claim 17, wherein the processing circuitry is further configured to select a receive beam from a plurality of receive beams having a reflected signal from a reflector, the selecting being based at least in part on a relationship between a beam power and beam delay, and a history of channel characteristics.
